(19) United States
(12) Patent Application Publication
(10) Pub. No.: US 2013/0079509 A1
(43) Pub. Date: Mar. 28, 2013

(54) SEPARATION PROCESS

(71) Applicants: Jari Mattila, Hankainrinne 8 (FI); Hannu Koivikko, Kolsarintie 4 (FI)

(72) Inventors: Jari Mattila, Hankainrinne 8 (FI); Hannu Koivikko, Kolsarintie 4 (FI)

(73) Assignee: DUPONT NUTRITION BIOSCIENCES APS, DK-1001 COPENHAGEN K, DK (DK)

(21) Appl. No.: 13/702,844

(22) PCT Filed: Jun. 7, 2011
(86) PCT No.: PCT/FI2011/050533

§ 371 Date: Dec. 7, 2012

(30) Foreign Application Priority Data
Jun. 7, 2010 (US) 61352050

(51) Int. Cl. B01D 65/06; B01D 61/02

(52) U.S. Cl. CPC B01D 65/06; B01D 61/027
USPC 536/127; 210/636

(57) ABSTRACT

A process of treating polymeric nanofiltration membranes before separation of low molecular weight compounds from a solution comprising the same by nanofiltration, characterized in that the treatment of the nanofiltration membranes is performed with an organic liquid under conditions which enhance the flux of the low molecular weight compounds to the nanofiltration permeate.

### FIELD OF THE INVENTION

The invention relates to a process of treating polymeric nanofiltration membranes, especially membranes selected from polyamide membranes. The process of the invention is based on treating the membranes with organic liquids, such as organic acids and alcohols at a higher concentration and at a high temperature for a prolonged time before their use in nanofiltration. It has been surprisingly found that the treatment process of the invention provides an improved throughput capacity, which remains at a high level in long term in successive nanofiltration cycles, while not essentially affecting the separation efficiency of the nanofiltration.

### BACKGROUND OF THE INVENTION

It is generally known in the art that various post-treatment methods are used by the manufacturers of nanofiltration membranes to increase the performance of asymmetric composite membranes and to stabilize the membranes in the longer term, see Nanofiltration—Principles and Applications, edited by A. I. Schäfer, A. G. Fane & T. D. Waite, 2005, pages 41-42 (3.2.7 Post treatment). The post-treatment may comprise annealing in water or under dry conditions, exposure to concentrated mineral acids, drying with solvent exchange techniques and treatment with conditioning agents. As useful solvent systems for asymmetric polyimide membranes in the solvent exchange techniques, a combination of isopropanol or methylketone with hexane as well as mixtures of lube oil, methylketone and toluene are specifically mentioned. It is also recited that conservation in conditioning agents, like lube oil, enhances the performance of asymmetric polyimide membranes. The post-treatment for the polyimide membranes in accordance with the cited reference is performed to improve the hydrophilic properties of the membranes.

Furthermore, the same textbook as mentioned above describes fouling prevention and cleaning of nanofiltration membranes on page 219 etc. Chemical cleaning agents and processes, including alkaline cleaning and acid cleaning, are described on pages 220-221. Nitric acid, citric acid, phosphonic acid and phosphoric acid are mentioned as examples of acidic cleaning agents.

Various conditioning and cleaning methods for nanofiltration membranes (Desal-5 DK, Desal-5 DL and NF270 membranes) in the recovery of xylose by nanofiltration have been disclosed by E. Sjöman et al. in “Xylose recovery by nanofiltration from different hemicellulose hydrolyzate feeds”, Journal of Membrane Science 310 (2008), pages 268-277. In accordance with this document, the virgin membranes are conditioned with an alkaline cleaning agent (0.5% P3-Ultrasil-110) at 2 bar and 45° C. for 30 minutes and rinsed with ion free water, followed by nanofiltration of a first batch and a second batch of the hemicellulose hydrolyzate, from which xylose is to be separated. After each batch, the membranes are cleaned with an acidic and alkaline cleaning agent. The acidic cleaning is done with 5% acetic acid for 30 minutes at 50° C. at 2 bar. The alkaline cleaning is done with 1% P3-Ultrasil-110 for 10 minutes at 50° C. at 2 bar, followed by further 2 minutes after a stop of 30 minutes. Furthermore, the cleaning comprises rinsing with ion free water. It is recited that the cleaning is done to stabilize the membranes to long-term filtration-cleaning cycles. The conditioning and cleaning methods described in this document have been carried out under relatively mild conditions, for example for relatively short periods of time and their purpose has been mostly to remove the fouling layer collected on the membrane during the nanofiltration of xylose solutions.

WO 02/053781 A1 and WO 02/053783 A1 mention the treatment of nanofiltration membranes with alkaline detergents and/or ethanol in the recovery of different chemical compounds, for example monosaccharides, such as xylose, by nanofiltration from a biomass hydrolysate. Furthermore, WO 2007/048879 A1 mentions the treatment of nanofiltration membranes by washing with an acidic washing agent in the recovery of xylose by nanofiltration from plant-based biomass hydrolysates.

Weng et al. discuss the retention of xylose and acetic acid at various initial acetic acid concentrations in “Separation of acetic acid from xylose by nanofiltration”, Separation and Purification Technology 67 (2009) 95-102. A negative retention of acetic acid was observed in the presence of xylose.

U.S. Pat. No. 5,279,739 discloses a polymeric composition useful in membrane technology such as nanofiltration. Suitable polymers for the composition include polyether sulfone, polysulfone and polyarylether sulfone. According to the examples, a suitable pore former may be added to the polymer composition prior to casting and hardening of the membranes. As suitable pore formers are mentioned low molecular weight organic compounds, inorganic salts and organic polymers. Furthermore, it is recited that other suitable pore formers include for example low molecular weight organic acids, such as acetic acid and propionic acid.

One of the problems associated with known nanofiltration processes comprising post-treatment, conditioning and cleaning methods under relatively mild conditions as described above is that the throughput capacity of the membranes has not been sufficient and/or has not remained stabile in the long run, but decreases too quickly in successive nanofiltration runs. Consequently, there is a need for more efficient treatment methods to achieve increased membrane throughput capacity, without having a negative effect on the membrane structure and on the separation efficiency.

### DEFINITIONS RELATING TO THE INVENTION

“Membrane throughput capacity” is expressed as the flux of the compound to be separated, e.g. as xylose flux for the case where xylose is the target compound to be separated by the nanofiltration process.

“Flux” or “permeate flux” refers to the amount (liters or kg) of the solution that permeates through the nanofiltration membrane during one hour calculated per one square meter of the membrane surface, l/(m²h) or kg/(m²h).

“Xylose flux” refers to the amount of xylose (g) that permeates through the nanofiltration membrane during one hour calculated per one square meter of the membrane surface, g/(m²h). Xylose flux may be determined by measuring the liquid flux and the content of dry substance and xylose in the permeate. The same definition applies to other target compounds to be separated. Consequently, for example “glucose flux” and “betaine flux” are defined in the same way.

“Separation efficiency” refers to the ability of the membranes in a nanofiltration process to separate the target compound(s) from the other compound in nanofiltration feed, expressed as the purity of the compound (% on DS) in the nanofiltration permeate compared to purity of the compound in the feed. The separation efficiency may also be expressed as the relation of two compounds to be separated from each other (their relation in the permeate compared to that in the feed).

“DS” refers to the dry substance content measured by Karl Fischer titration or by refractometry (RI), expressed as % by weight.

“MgSO₄ retention” refers to the observed retention of MgSO₄, which is a measure of the membrane selectivity toward MgSO₄ as shown below:

R_{MgSO4}=1−cₚ(MgSO₄)/c_{f}(MgSO₄)

where R_{MgSO4} is the observed retention of MgSO₄
cₚ(MgSO₄) is the concentration of MgSO₄ in the permeate (g/100 g solution)
c_{f}(MgSO₄) is the concentration of MgSO₄ in the feed (g/100 g solution).

“Membrane treatment” refers to modifying a nanofiltration membrane with chemicals to increase the membrane throughput capacity. The membrane treatment in accordance with the invention may be performed by membrane manufacturers as post-treatment in the finishing stage of membrane manufacturing. The membrane treatment in accordance with the present invention may also be made as pretreatment in the nanofiltration operation.

“Membrane cleaning” and “membrane washing” refer to removing membrane preserving compounds from virgin membranes or removing foulants/contaminants/impurities which have been accumulated on the nanofiltration membranes (surfaces and pores thereof) during the nanofiltration operation or during storage of the nanofiltration membranes.

### DESCRIPTION OF THE INVENTION

An object of the present invention is thus to provide a process of treating nanofiltration membranes so as to alleviate the above-mentioned disadvantages relating non-sufficient or reduced membrane throughput capacity in known nanofiltration methods.

The invention relates to a process of treating polymeric nanofiltration membranes before separation of low molecular weight compounds from a solution containing the same by nanofiltration, characterized in that the treatment of the nanofiltration membranes is performed with an organic liquid under conditions which enhance the flux of the low molecular weight compounds to the nanofiltration permeate while essentially retaining the separation efficiency of the low molecular weight compounds.

The organic liquid used as the treatment liquid may be a solution comprising one or more compounds selected from organic acids and alcohols. The treatment liquid may also be an industrial process stream containing one or more of said compounds.

The organic acids may be selected from formic acid, acetic acid, propionic acid, lactic acid, oxalic acid, citric acid, glycolic acid and aldonic acids. The aldonic acids may be selected from xylonic acid and gluconic acid, for example.

The alcohol may be selected from methanol, ethanol, n-propanol, isopropanol and glycerol, for example.

In a typical embodiment of the invention, the treatment liquids are aqueous solutions containing one or more compounds recited above. The concentration of the recited compounds in the treatment liquid may be 2% to 98% by weight, preferably 10% to 60% by weight, more preferably 10% to 40% by weight.

The treatment liquids may also be for example industrial process streams, which contain one or more of the recited compounds in concentrations mentioned above. The industrial process streams may be selected from various side streams from industrial plants, for example. Examples of useful industrial process streams are for instance side streams from wood processing industry and biorefineries, which may typically contain recites acids or alcohols in appropriate ranges. If appropriate, the industrial process streams may be diluted or concentrated to the desired concentration.

The treatment in accordance with the present invention is performed at a temperature of 20° to 100° C., preferably 20° C. to 90° C. and more preferably 40° C. to 80° C.

The treatment time may be 1 to 150 hours, preferably 2 to 100 hours, more preferably 20 to 50 hours.

The treatment conditions (temperature and time) may vary within a wide range depending on the selected treatment liquid and the concentration thereof and the selected membrane, for example.

In one specific embodiment of the invention, the treatment is performed with a solution of formic acid under the following conditions:

acid concentration 5% to 80% by weight, preferably 10% to 45% by weight

treatment temperature 40° C. to 80° C., preferably 65° C. to 75° C.,

treatment time 20 to 90 hours.

In a further specific embodiment of the invention, the treatment is performed with a solution of lactic acid under the following conditions:

acid concentration 10% to 95% by weight, preferably 30% to 85% by weight,

treatment temperature 40° C. to 80° C., preferably 65° C. to 75° C.,

treatment time 20 to 90 hours.

In a still further specific embodiment of the invention, the treatment is performed with a solution of isopropyl alcohol under the following conditions:

alcohol concentration 5% to 80% by weight, preferably 15% to 45% by weight

treatment temperature 40° C. to 80° C., preferably 65° C. to 75° C.,

treatment time 20 to 90 hours.

In a still further specific embodiment of the invention, the treatment is performed with a solution of acetic acid under the following conditions:

acid concentration of 10% to 100% by weight, preferably 10% to 60% by weight,

treatment temperature 40° C. to 80° C., preferably 65° C. to 75° C.,

treatment time 20 to 70 hours, preferably 40 to 60 hours.

In one embodiment of the invention, mixtures of an organic acid and an alcohol may be used as the treatment liquid. One example of a useful mixture is a mixture of isopropanol and formic acid.

In a further embodiment of the invention, the treatment may comprise two or more successive steps, for example a first treatment with an alcohol, such as isopropanol, and a second treatment with an organic acid, such as acetic acid.

In practice, the treatment may be performed by immersing, soaking or incubating the membrane elements in the treatment liquid. Mixing may be applied, if desired. The treatment may also be performed by recycling the pretreatment liquid in a nanofiltration apparatus provided with the membrane elements to be treated.

The treatment process of the present invention is followed by the actual nanofiltration for separating target compounds from various nanofiltration feeds.

Consequently, in a further embodiment of the invention, the process further comprises nanofiltration of a nanofiltration feed comprising low molecular weight compounds to obtain a nanofiltration retentate and a nanofiltration permeate, whereby said low molecular weight compound(s) are separated into the nanofiltration permeate with improved flux of the compound(s), while essentially retaining the separation efficiency. The nanofiltration is performed with nanofiltration membranes treated as described above.

The flux improvement of the compound(s) is more than 20%, preferably more than 50%, more preferably more than 100% compared to the flux with untreated membranes.

The treatment of the present invention may be applied for example to the nanofiltration processes disclosed in WO 02/053781 A1 and 02/053783 A1 and WO 2007/048879 A1, which are incorporated herein by reference.

The compounds to be separated by the nanofiltration are typically low molecular weight compounds which have a molar mass of up to 360 g/mol.

The low molecular weight compounds to be separated may be selected from sugars, sugar alcohols, inositols, betaine, glycerol, amino acids, uronic acids, carboxylic acids, aldonic acids and inorganic and organic salts.

In one embodiment of the invention, the sugars are monosaccharides. The monosaccharides may be selected from pentoses and hexoses. The pentoses may be selected from xylose and arabinose. In one embodiment of the invention, the pentose is xylose.

The hexoses may be selected from glucose, galactose, rhamnose, mannose, fructose and tagatose. In one embodiment of the invention, the hexose is glucose.

The sugar alcohols may be selected from xylitol, sorbitol and erythritol, for example.

The carboxylic acids may be selected from citric acid, lactic acid, gluconic acid, xylonic acid and glucuronic acid.

The inorganic salts to be separated may be selected from monovalent anions, such as Cl⁻, for example.

In a preferred embodiment of the invention, the compounds to be separated into the nanofiltration permeate may be product compounds, such as xylose, glucose and betaine.

In a further embodiment of the invention, the compounds to be separated into the nanofiltration permeate may be impurities, such as inorganic salts, especially monovalent salts like NaCl, NaHSO₄ and NaH₂PO₄.

The starting material used as the nanofiltration feed in accordance with the present invention may be selected from plant-based biomass hydrolysates and biomass extracts and fermentation products thereof.

In one embodiment of the invention, the plant-based biomass hydrolysates may be derived from wood material from various wood species, such as hardwood, various parts of grain, bagasse, coconut shells, cottonseed skins etc. In one embodiment of the invention, the starting material may be a spent liquor obtained from a pulping process, for example a spent sulphite pulping liquor obtained from hardwood sulphite pulping. In a further embodiment of the invention, the starting material is a sugar beet based solution a or sugar cane based solution, such as molasses or vinasse.

In a further embodiment of the invention, the nanofiltration feed is selected from starch hydrolysates, oligosaccharide-containing syrups, glucose syrups, fructose syrups, maltose syrups and corn syrups.

In a further embodiment of the invention, the nanofiltration feed may be a lactose-containing dairy product, such as whey.

In one embodiment of the invention, the nanofiltration comprises the separation of xylose from a spent liquor obtained from a pulping process, for example a spent sulphite pulping liquor obtained from hardwood sulphite pulping. Xylose is recovered as a product from the nanofiltration permeate.

In a further embodiment of the invention, the nanofiltration comprises the separation of betaine from a sugar beet based solution, such as molasses or vinasse. Betaine may be recovered as a product from the nanofiltration permeate.

In a still further embodiment of the invention, the nanofiltration comprises the separation of glucose from a glucose syrup, such as dextrose corn syrup. Glucose is recovered as a product from the nanofiltration permeate.

In a still further embodiment of the invention, the nanofiltration comprises the separation of inorganic salts, especially monovalent salts, from a lactose-containing dairy product, for example whey. The salts are separated as impurities into the nanofiltration permeate.

The polymeric nanofiltration membranes useful in the present invention include, for example, aromatic polyamide membranes such as polypiperazineamide membranes, aromatic polyamine membranes, polyether sulfone membranes, sulfonated polyether sulfone membranes, polyester membranes, polysulfone membranes, polyvinyl alcohol membranes and combinations thereof. Composite membranes composed of layers of one or more of the above-mentioned polymeric materials and/or other materials are also useful in the present invention.

Preferred nanofiltration membranes are selected from polyamide membranes, especially polypiperazineamide membranes. As examples of useful membranes can be mentioned Desal-5 DL, Desal-5 DK and Desal HL by General Electrics Osmonics Inc., NF 270 and NF 90 by Dow Chemicals Co., and NE40 and NE70 by Woongjin Chemicals Co.

The nanofiltration membranes useful for the treatment of the invention typically have a cut-off size of 150 to 1000 g/mol, preferably 150 to 250 g/mol.

The nanofiltration membranes which are useful in the present invention may have a negative or positive charge. The membranes may be ionic membranes, i.e. they may contain cationic or anionic groups, but even neutral membranes are useful. The nanofiltration membranes may be selected from hydrophobic and hydrophilic membranes.

Typical forms of the membranes are spiral wound membranes and flat sheet membranes assembled in plate and frame modules. The membrane configuration may be also selected e.g. from tubes, and hollow fibers.

In one embodiment of the invention, the treatment is done on non-used virgin membranes, before the membranes are taken into use. In another embodiment of the invention, the treatment may be done on used membranes before a new nanofiltration. The treatment may be regularly repeated for example within intervals of 3 to 6 months during the nanofiltration use.

The nanofiltration conditions (such as the temperature and pressure, the dry substance content of the nanofiltration feed and the content of the low molecular weight compound in the nanofiltration feed) may vary depending on the selected starting material (nanofiltration feed), the compound to be separated and the selected membrane. The nanofiltration conditions may be selected for example from those described in WO 02/053781 A1 and 02/053783 A1 and WO 2007/048879 A1, which are incorporated herein by reference.

The nanofiltration temperature may be in the range of 5 to 95° C., preferably 30 to 80° C. The nanofiltration pressure may be in the range of 10 to 50 bar, typically 15 to 35 bar.

The dry substance content of the nanofiltration feed may be in the range of 5% to 60% by weight, preferably 10% to 40% by weight, more preferably 20% to 35% by weight.

The content of the low molecular weight compounds, e.g. xylose or betaine, in nanofiltration feeds selected from plant-based biomass hydrolysates and extracts may be in the range of 10 to 65% on DS, preferably 30 to 65% on DS. The content of the low molecular weight compounds, e.g. glucose, in nanofiltration feeds selected from starch hydrolysates, oligosaccharide-containing syrups, glucose syrups, fructose syrups, maltose syrups and corn syrups may be in the range of 90 to 99%, preferably 94 to 99%.

It was found that the preteatment process of the present invention provides a considerable increase in the membrane throughput capacity for the low molecular weight compounds which are separated into the nanofiltration permeate. For example in the separation of xylose, the increase in the capacity may be even up to 300% or higher, measured for xylose separation as the increased xylose flux through the membrane, while retaining the separation efficiency. It was also found that the achieved capacity increase was stabile during repeated nanofiltration cycles. At the same time, the separation efficiency measured for example as the purity of xylose or as the separation of xylose from glucose remained the same or even improved along with the higher capacities.

In one embodiment of the invention, the flux of the low molecular weight compounds to the nanofiltration permeate is in the range of 10 to 20 000 g/m²h.

In the separation of sugars, the flux of the sugars to the nanofiltration permeate may be in the range of 20 to 15 000 g/m²h, preferably 100 to 8 000 g/m²h, most preferably 100 to 4000 g/m²h.

In the separation of xylose, the flux of xylose to the nanofiltration permeate may be in the range of 100 to 10 000 g/m²h, preferably 100 to 8 000 g/m²h, most preferably 100 to 4000 g/m²h.

In the separation of glucose, the flux of glucose to the nanofiltration permeate may be in the range of 200 to 15 000 g/m²h, preferably 200 to 10 000 g/m²h, most preferably 200 to 8000 g/m²h.

In one specific embodiment of the invention, the invention relates to a process of separating and recovering xylose from a xylose-containing nanofiltration feed by nanofiltration with a polymeric nanofiltration membrane, comprising

treating the membrane with an organic liquid comprising one or more compounds selected from formic acid, lactic acid, acetic acid, isopropanol, ethanol and methanol in the following conditions:
compound concentration 10 to 80% by weight,
treatment temperature 40 to 90° C., and
treatment time 2 to 100 hours,

to obtain a treated nanofiltration membrane, followed by

nanofiltering the xylose-containing nanofiltration feed with the treated nanofiltration membrane with a xylose flux of 200 to 10 000 g xylose/m²h to the nanofiltration permeate, and

recovering xylose from the nanofiltration permeate.

### EXAMPLES

The invention will now be described in greater detail with following examples, which are not construed as limiting the scope of the invention.

The following membranes are used in the examples:

Desal-5 DL (a four-layered membrane consisting of a polyester layer, a polysulfone layer and two proprietary layers, having a cut-off-size of 150 to 300 g/mol, permeability (25° C.) of 7.6 l/(m²h bar), MgSO₄-retention off 96% (2 g/l), manufacturer GE Osmonics Inc.),

Desal-5 DK (a four-layered membrane consisting of a polyester layer, a polysulfone layer and two proprietary layers, having a cut-off-size of 150 to 300 g/mol, permeability (25° C.) of 5.4 l/(m²h bar), MgSO₄-retention off 98% (2 g/l), manufacturer GE Osmonics Inc.),

NE70 (a thin-film composite polyamide membrane, manufacturer Woongjin Chemical Co., Ltd).

HPLC (for the determination of sugars and betaine) refers to liquid chromatography. RI detection was used.

### Example 1

### Xylose Flux Test after Treatment with Acetic Acid or Formic Acid

A membrane treatment test was carried out with flat sheets cut from spiral wound elements. The membranes tested were GE Osmonics Desal 5 DL and GE Osmonics Desal 5 DK. The filtration unit used in the test was Alfa Laval LabStak M20.

The membrane sheets were first washed with ion free water for 48 hours at 25° C. to remove all membrane preserving compounds. Then the membranes were washed with an alkaline washing agent for 30 minutes by soaking in 0.1% alkaline solution (Ecolab Ultrasil 112) at 30° C. Then the membranes were flushed with ion free water. The next step was washing by soaking the membranes for 2 minutes in 0.1% acetic acid at 30° C. followed by flushing with IEX (ion exchanged) water.

After the pre-washing steps, the membrane sheets were treated by incubation in various test liquids at 70° C. for 48 hours. After the incubation, the membrane sheets were flushed well with ion free water before assembling them to the filtration unit.

A xylose flux test was carried out with a 40% xylose solution, made by dissolving pure xylose into ion free water. The xylose flux test through the membrane was done at 30 bar at 60° C., and the cross flow velocity was adjusted to 3 m/s. The filtrations were done with a reflux mode, i.e. all permeates were introduced back into the feed tank. The filtration time before the measurements and sample taking was 30 minutes.

The permeate flux values were registered and permeate samples were analysed for calculating the xylose flux. The treatment solutions and xylose fluxes measured with respective membranes are presented in Table 1.

TABLE 1

| Treatment liquid | Osmonics Desal 5 DL | Osmonics Desal 5 DK |
|---|---|---|
| 48 h/70° C. | Xylose flux, g/m²/h | Xylose flux, g/m²/h |
| Ion free water | 1 200 | 1 100 |
| 2% acetic acid | 1 000 | 800 |
| 15% acetic acid | 1 500 | 1 600 |
| 5% formic acid | 5 700 | 1 800 |
| 15% formic acid | 7 500 | 3 700 |

### Example 2

### Further Xylose Flux Test after Treatment with Acetic Acid or Formic Acid

A further membrane treatment test was carried out with flat sheets cut from spiral wound elements. The membranes tested were GE Osmonics Desal 5 DL, GE Osmonics Desal 5 DK and Woongjin NE70 membrane. The filtration unit used in the test was Alfa Laval LabStak M20.

The membrane sheets were first washed with ion free water for 48 hours at 25° C. to remove all membrane preserving compounds. Then the membranes were washed with an alkaline washing agent for 30 minutes by soaking in 0.1% alkaline solution (Ecolab 20 Ultrasil 112) at 30° C. After alkaline wash, the membranes were flushed with ion free water. The next step was washing by soaking the membranes for 2 minutes in 0.1% acetic acid at 30° C. followed by flushing with IEX (ion exchanged) water.

After the pre-washing steps, the membrane sheets were treated by incubation in various test liquids at 70° C. for 48 hours. After the incubation, the membrane sheets were flushed well with ion free water before assembling them to the filtration unit.

A xylose flux test was carried out with a 25% DS industrial xylose solution, which was a chromatographically separated xylose fraction of Mg-based acid spent sulphite pulping liquor, obtained according to WO 021 053 783 A1. The composition of the industrial xylose solution was: glucose 4.8% on DS, xylose 45.8% on DS, rhamnose 4.5% on DS, arabinose 0.9% on DS, mannose 4.5% on DS. The xylose flux test was done at 30 bar at 60° C., and the cross flow velocity was adjusted to 3 m/s. Filtrations were done with a reflux mode, i.e. all permeates were introduced back into the feed tank. The filtration time before the measurements and sample taking was 30 minutes.

The permeate flux values were registered and permeate samples were analysed for calculating the xylose flux. The treatment solutions and xylose fluxes measured with respective membranes are presented in Table 2.

TABLE 2

| | Osmonics | Osmonics | Woongjin |
|---|---|---|---|
| | Desal 5 DL | Desal 5 DK | NE70 |
| Treatment liquid | Xylose flux, | Xylose flux, | Xylose flux, |
| 48 h/70° C. | g/m²/h | g/m²/h | g/m²/h |
| Ion free water | 880 | 560 | 440 |
| 2% acetic acid | 920 | 520 | 270 |
| 5% formic acid | 890 | 544 | 350 |
| 15% formic acid | 1 400 | 1 010 | 600 |

### Example 3

### Xylose Flux Test after Treatment with Isopropanol/Formic Acid

A further membrane treatment test was carried out with flat sheets cut from spiral wound elements. The membranes tested were GE Osmonics Desal 5 DL and Woongjin NE70 membrane. The filtration unit used in the test was Alfa Laval LabStak M20.

The membrane sheets were first washed with ion free water for 48 hours at 25° C. to remove all membrane preserving compounds. Then the membranes were washed with an alkaline washing agent for 30 minutes by soaking in 0.1% alkaline solution (Ecolab 20 Ultrasil 112) at 30° C. The membranes were flushed with ion free water. The next step was washing by soaking the membranes for 2 minutes in 0.1% acetic acid at 30° C. followed by flushing with IEX (ion exchange) water.

After the pre-washing steps, the membrane sheets were treated by incubation in various test liquids at 70° C. for 48 hours. After the high temperature incubation, the membrane sheets were flushed well with ion free water before assembling them to the filtration unit.

The first test with the treated membranes was a MgSO₄ retention test done at 25° C. with a 2 000 ppm MgSO₄ solution at a constant inlet pressure (8.3 bar).

Thereafter a xylose flux test was carried out with a 20% DS industrial xylose solution, made a similar way as in Example 2. The xylose flux test was done at 30 bar at 60° C., and the cross flow velocity was adjusted to 3 m/s. The filtrations were done with a reflux mode, e.g. all permeates were introduced back into the feed tank. The filtration time before the measurements and sample taking was 30 minutes.

The permeate flux values were registered and the permeate samples were analysed for calculating the xylose flux. The treatment solutions and the xylose fluxes measured with respective membranes are presented in Table 3.

TABLE 3

| | Retention test | | Xylose flux test | |
|---|---|---|---|---|
| | Osmonics | Woongjin | Osmonics | Woongjin |
| | Desal 5 DL | NE70 | Desal 5 DL | NE70 |
| | MgSO₄ | MgSO₄ | Xylose | Xylose |
| Treatment liquid | retention, | retention, | flux, | flux, |
| 48 h/70° C. | % | % | g/m²/h | g/m²/h |
| Ion free water | 99.3 | 98.5 | 540 | 400 |
| 15% isopropanol | 99.5 | 99.4 | 1 100 | 650 |
| 15% isopropanol + | 99.5 | 99.5 | 1 200 | 570 |
| 2% formic acid | | | | |

### Example 4

### Xylose Flux and Xylose Purity Test after Treatment with Formic Acid

A further membrane treatment test was carried out with flat sheets cut from spiral wound elements. The membrane tested was Woongjin NE70 membrane. The filtration unit used in the test was Alfa Laval LabStak M20.

The membrane sheets were first washed with ion free water for 48 hours at 25° C. to remove all membrane preserving compounds. Then the membranes were washed with an alkaline washing agent for 30 minutes by soaking in 0.1% alkaline solution (Ecolab 20 Ultrasil 112) at 30° C. Then the membranes were flushed with ion free water. The next step was washing by soaking the membranes for 2 minutes in 0.1% acetic acid at 30° C. followed by flushing with IEX (ion exchange) water.

After the pre-washing steps, the membrane sheets were treated by incubation in various test liquids at 70° C. for 23 to 145 hours. The test liquids were formic acid (FA) solutions with varying concentrations. After the incubation, the membrane sheets were flushed well with ion free water before assembling them to the filtration unit.

The first test with the treated membranes was a xylose flux test carried out with a 25% DS industrial xylose solution, made in a similar way as in Example 2. The xylose flux test was done at 30 bar at 60° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the xylose content for calculating the xylose flux. The treatment solutions and the xylose fluxes measured with respective membranes are presented in Table 4.

TABLE 4

| | | Xylose purity |
|---|---|---|
| Treatment liquid, | Xylose flux, | in permeate, |
| time | g/m²/h | % on DS |
| 13.2% FA, 84 h | 425 | 55.2 |
| 20% FA, 48 h | 603 | 53.3 |
| 20% FA, 120 h | 977 | 53.1 |
| 30% FA, 84 h | 1 181 | 58.2 |
| 30% FA, 84 h | 1 045 | 57.0 |
| 30% FA, 84 h | 1 073 | 58.4 |
| 30% FA, 84 h | 983 | 57.2 |
| 30% FA, 84 h | 677 | 58.7 |
| 30% FA, 145 h | 2 704 | 46.0 |
| 30% FA, 23 h | 435 | 57.3 |
| 40% FA, 48 h | 713 | 55.6 |
| 40% FA, 120 h | 2 392 | 53.2 |
| 46.8% FA, 84 h | 2 298 | 52.7 |

### Example 5

### Further Xylose Flux Test after Treatment with Acetic Acid or Formic Acid

A membrane treatment test was carried out with flat sheets cut from spiral wound elements. The membranes tested were GE Osmonics Desal 5 DL and GE Osmonics Desal 5 DK. The filtration unit used in the test was Alfa Laval LabStak M20.

The membrane sheets were first washed with ion free water for 48 hours at 25° C. to remove all membrane preserving compounds. Then the membranes were washed with an alkaline washing agent minutes by soaking in 0.1% alkaline solution (Ecolab, Ultrasil 112) at 30° C. Then the membranes were flushed with ion free water. The next step was washing by soaking the membranes for 2 minutes in 0.1% acetic acid at 30° C. followed by flushing with IEX (ion exchange) water.

After the pre-washing steps, the membrane sheets were treated by incubation in various test liquids at 70° C. for 48 hours. After the incubation, the membrane sheets were flushed well with ion free water before assembling them to the filtration unit.

A xylose flux test A with the treated membranes was carried out with a 25% DS industrial xylose solution, made in the same way as in Example 2. The xylose flux test was done at constant pressure 30 bar at 60° C. and the cross flow velocity was adjusted to 3 m/s. The filtrations were done with a reflux mode, i.e. all permeates were introduced back into the feed tank. The filtration time before measurements and sample taking and was 30 minutes.

The permeate flux values were registered and the permeate samples were analysed with HPLC to measure the xylose content for calculating the xylose flux. The treatment solutions and the xylose fluxes measured with respective membranes for test A are presented in Table 5.

The first xylose flux measurement (test A) was followed by a 2 days constant flux batch run with the same industrial xylose solution. After the 2 days batch run, the membranes were washed first for 30 minutes with a 2% acetic acid solution at 40° C. at a feed pressure of 2 bar and then for 30 minutes with 0.3% Ecolab 20 Ultrasil 112 solution. Thereafter a new xylose flux test B was carried out in similar conditions for 2 days as described in test A. Table 5 also represents the results from test B. It can be seen that the achieved capacity increase was stabile, and the ranking of capacities remained the same after the exposure to the industrial grade xylose solution.

TABLE 5

| | Xylose flux A, | Xylose flux B, |
|---|---|---|
| Treatment solution, membrane | g/m²/h | g/m²/h |
| Ion exchanged water, Desal 5 DK | 259 | 349 |
| 2% acetic acid, Desal 5 DK | 315 | 485 |
| 15% acetic acid, Desal 5 DK | 629 | 768 |
| 5% formic acid, Desal 5 DK | 490 | 684 |
| 15% formic acid, Desal 5 DK | 829 | 912 |
| Ion exchanged water, Desal 5 DL | 473 | 511 |
| 2% acetic acid, Desal 5 DL | 532 | 690 |
| 15% acetic acid, Desal 5 DL | 1 023 | 1 105 |
| 5% formic acid, Desal 5 DL | 690 | 885 |
| 15% formic acid, Desal 5 DL | 1 205 | 1 235 |

### Example 6

### Xylose Flux and Xylose/Glucose Purity Test after Treatment with Various Acids

A membrane treatment test was carried out with flat sheets cut from spiral wound elements. The membranes tested in the treatment test were GE Osmonics Desal 5 DL, GE Osmonics Desal 5 DK and Woongjin NE70 membrane. The filtration unit used in the test was Alfa Laval LabStak M20.

The membrane sheets were first washed with ion free water for 48 hours at 25° C. to remove all membrane preserving compounds. Then the membranes were washed with an alkaline washing agent minutes by soaking in 0.1% alkaline solution (Ecolab, Ultrasil 112) at 30° C. The membranes were flushed with ion free water. The next step was washing the membranes by soaking for 2 minutes in 0.1% acetic acid at 30° C. followed by flushing with IEX (ion exchange) water.

After the pre-washing steps, the membrane sheets were treated by incubation in various test liquids at 70° C. for 48 hours. After the high temperature incubation, the membrane sheets were flushed well with ion free water before assembling them to the filtration unit.

A xylose flux test was carried out with a 25% DS industrial xylose solution, made in the same way as in Example 2. The xylose content of the solution was 49.4% and the glucose content of the solution was 4.1% on DS, whereby the glucose/xylose ratio (%) was 8.2. The xylose flux test was done at 30 bar at 60° C., and the cross flow velocity was adjusted to 3 m/s. The filtrations were done with a reflux mode, i.e. all permeates were introduced back into the feed tank. The filtration time before the measurements and sample taking was 30 minutes.

The permeate flux values were registered and the permeate samples were analysed for calculating the xylose flux. The treatment solutions and the xylose fluxes measured with respective membranes are presented in Table 6. Simultaneously, the permeate quality was measured by analysing the xylose and glucose purity and calculating the ratio of glucose to xylose. It can be seen that the separation of xylose from glucose remains the same or is even improved together with the higher capacities achieved.

TABLE 6

| | Xylose | Xylose, | Glucose, | Glucose/ |
|---|---|---|---|---|
| | flux, | % on | % on | Xylose, |
| Treatment liquid, membrane | g/m²/h | DS | DS | % |
| 0.2% (pH 1.88) sulphuric | 358 | 56.1 | 1.9 | 3.3 |
| acid, NE70 | | | | |
| 0.2% (pH 1.88) sulphuric | 292 | 58.1 | 2.2 | 3.8 |
| acid, Desal 5 DK | | | | |
| 0.2% (pH 1.88) sulphuric | 425 | 58.4 | 1.9 | 3.3 |
| acid, Desal 5 DL | | | | |
| 15% formic acid, NE70 | 384 | 57.8 | 1.9 | 3.4 |
| 15% formic acid, Desal 5 DK | 579 | 61.2 | 2.0 | 3.3 |
| 15% formic acid, Desal 5 DL | 729 | 59.6 | 1.9 | 3.1 |
| 5% formic acid, NE70 | 233 | 60.0 | 2.1 | 3.5 |
| 5% formic acid, Desal 5DK | 343 | 61.2 | 2.1 | 3.4 |
| 5% formic acid, Desal 5 DL | 500 | 60.0 | 2.0 | 3.3 |
| 2% acetic acid, NE70 | 198 | 60.2 | 2.3 | 3.8 |
| 2% acetic acid, Desal 5 DK | 356 | 63.3 | 2.4 | 3.7 |
| 2% acetic acid, Desal 5 DL | 556 | 59.8 | 2.2 | 3.7 |
| Ion exchanged water, NE70 | 303 | 58.3 | 2.1 | 3.7 |
| Ion exchanged water, Desal 5 | 338 | 61.6 | 2.1 | 3.4 |
| DK | | | | |
| Ion exchanged water, Desal 5 | 567 | 59.7 | 2.2 | 3.6 |
| DL | | | | |

### Example 7

### Permeate Flux, Xylose Flux and Xylose Purity Test after Treatment with Formic Acid

A membrane treatment test was carried out with flat sheets cut from spiral wound elements. The membrane tested was Osmonics Desal 5 DL membrane. The filtration unit used in the test was Alfa Laval LabStak M20.

All the tested membrane sheets were first washed with ion free water for 48 hours at 25° C. to remove all membrane preserving compounds. Then the membranes were washed with an alkaline washing agent for 30 minutes by soaking in 0.1% alkaline solution (Ecolab Ultrasil 112) at 30° C. The membranes were flushed with ion free water. The next step was washing by soaking the membranes for 2 minutes in 0.1% acetic acid at 30° C. followed by flushing with IEX (ion exchange) water.

After the pre-washing steps, the membrane sheets were treated by incubation in various test liquids at 70° C. for 23 to 145 hours. The test liquids were formic acid (FA) solutions with varying concentrations. After the incubation, the membrane sheets were flushed well with ion free water before assembling them to the nanofiltration test unit.

A xylose flux test with the treated membranes was carried out with a 25% DS industrial xylose solution, made in the same way as in Example 2. The xylose flux test was done at 30 bar at 65° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the xylose content for the calculation of xylose flux. The treatments and the xylose fluxes measured with respective membranes are presented in Table 7.

TABLE 7

| | Permeate | Xylose | Xylose purity |
|---|---|---|---|
| Treatment liquid, | flux, | flux, | in permeate, |
| time | kg/h · m² | g/m²/h | % on DS |
| Water, 145 h | 8.3 | 680 | 56.0 |
| 20% FA, 48 h | 15.5 | 1365 | 59.5 |
| 20% FA, 120 h | 18.0 | 1601 | 57.2 |
| 40% FA, 48 h | 18.8 | 1670 | 59.2 |
| 40% FA, 120 h | 21.0 | 1855 | 59.9 |
| 13% FA, 84 h | 12.7 | 1092 | 58.1 |
| 47% FA, 84 h | 19.5 | 1698 | 58.4 |
| 30% FA, 24 h | 17.2 | 1531 | 59.6 |
| 30% FA, 145 h | 23.0 | 2022 | 58.5 |
| 30% FA, 84 h | 19.2 | 1709 | 58.3 |
| 30% FA, 84 h | 18.5 | 1637 | 56.8 |
| 30% FA, 84 h | 18.3 | 1633 | 58.1 |
| 30% FA, 84 h | 17.7 | 1532 | 56.9 |
| 30% FA, 84 h | 18.5 | 1701 | 58.2 |

### Example 8

### Water Flux, Xylose Flux and Xylose Purity Test after Treatment with Acetic Acid

A membrane treatment test was carried out with flat sheets cut from spiral wound elements. The membrane tested was Woongjin NE70 membrane. The filtration unit used in the test was Alfa Laval LabStak M20.

All the tested membrane sheets were first washed with ion free water for 48 hours at 25° C. to remove all membrane preserving compounds. Then the membranes were washed with an alkaline washing agent for 30 minutes by soaking in 0.1% alkaline solution (Ecolab Ultrasil 112) at 30° C. The membranes were flushed with ion free water. The next step was washing by soaking the membranes for 2 minutes in 0.1% acetic acid at 30° C. followed by flushing with IEX (ion exchange) water.

After the pre-washing steps, the membrane sheets were treated by incubation in various test liquids at 70° C. for 23 to 145 hours. The test liquids were acetic acid solutions with varying concentrations. After the incubation, the membrane sheets were flushed well with ion free water before assembling them to the nanofiltration test unit.

The first test with the treated membranes was a test for determining MgSO₄ retention and water flux. The test was carried out with a 2 000 ppm MgSO₄ solution at 8.3 bar/25° C., with a reflux mode, e.g. all permeates were introduced back into the feed tank. The filtration time before the measurements and sample taking and was 60 minutes.

The second test with the treated membranes was a xylose flux test carried out with a 25% DS industrial xylose solution, made in the same way as in Example 2. The xylose flux test was done at 30 bar/65° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the xylose content for calculation of xylose flux. The treatments and the xylose fluxes measured with respective membranes are presented in Table 8.

TABLE 8

| | Retention test | | Xylose flux test | |
|---|---|---|---|---|
| | Water | MgSO₄ | Xylose | Xylose purity |
| | flux, | retention, | flux, | in permeate, |
| Treatment liquid, time | kg/h · m² | % | g/m2/h | % on DS |
| Water, 145 h | 78.7 | 99.6 | 363 | 57.6 |
| 20% acetic acid, 48 h | 60.7 | 98.0 | 306 | 57.9 |
| 20% acetic acid, 120 h | 64.0 | 96.0 | 374 | 58.0 |
| 30% acetic acid, 84 h | 67.3 | 98.4 | 431 | 56.5 |
| 30% acetic acid, 84 h | 59.3 | 97.6 | 469 | 57.8 |
| 30% acetic acid, 84 h | 76.0 | 96.5 | 511 | 56.6 |
| 30% acetic acid, 84 h | 54.7 | 96.6 | 446 | 57.9 |
| 30% acetic acid, 84 h | 72.7 | 98.1 | 577 | 54.8 |
| 30% acetic acid, 145 h | 48.7 | 97.1 | 572 | 59.0 |
| 30% acetic acid, 23 h | 76.7 | 97.4 | 382 | 55.5 |
| 40% acetic acid, 48 h | 62.7 | 97.8 | 462 | 58.5 |
| 40% acetic acid, 120 h | 53.3 | 96.9 | 535 | 57.2 |
| 47% acetic acid, 84 h | 48.0 | 98.0 | 489 | 57.1 |

### Example 9

### Water Flux, Xylose Flux and Xylose Purity Test after Treatment with Isopropyl Alcohol

A further treatment test was carried out with flat sheets cut from spiral wound element. The membrane tested was GE Osmonics Desal 5 DL membrane. The filtration unit used in the test was Alfa Laval LabStak M20.

The membrane sheets were pre-washed with procedure similar to that of example 7.

After the pre-washing steps, the membrane sheets were treated by incubation in various test liquids at 70° C. for 23 to 145 hours. The test liquids were aqueous isopropanol (IPA) solutions with varying concentrations. After the incubation, the membrane sheets were flushed well with ion free water before assembling them to the nanofiltration test unit.

The first test with the treated membranes was a test for determining MgSO₄ retention and water flux. The test was carried out with a 2 000 ppm MgSO₄ solution at 8.3 bar at 25° C., with a reflux mode, e.g. all permeates were introduced back into the feed tank. The filtration time before the measurements and sample taking and was 60 minutes.

The second test with the treated membranes was a xylose flux test carried out with a 25% DS industrial xylose solution, similar to the one used in Example 2. The xylose flux test was done at 30 bar at 65° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the xylose content for calculating the xylose flux. The treatment solutions and the xylose fluxes measured with respective membranes are presented in Table 9.

TABLE 9

| | Retention test | | Xylose flux test | |
|---|---|---|---|---|
| | Water | MgSO₄ | Xylose | Xylose purity |
| | flux, | retention, | flux, | in permeate, |
| Treatment | kg/h · m² | % | g/m2/h | % on DS |
| Water, 145 h | 78.7 | 99.6 | 363 | 57.6 |
| 20% IPA, 48 h | 78.7 | 99.6 | 599 | 57.1 |
| 20% IPA, 120 h | 74.7 | 99.1 | 615 | 59.4 |
| 50% IPA, 48 h | 71.3 | 99.2 | 619 | 59.7 |
| 50% IPA, 120 h | 77.3 | 99.3 | 640 | 59.2 |
| 10% IPA, 84 h | 78.7 | 99.2 | 560 | 60.1 |
| 60% IPA, 84 h | 71.3 | 97.6 | 587 | 59.9 |
| 35% IPA, 22 h | 69.3 | 97.4 | 632 | 57.4 |
| 35% IPA, 145 h | 70.7 | 99.4 | 696 | 59.1 |
| 35% IPA, 84 h | 70.0 | 99.2 | 704 | 58.8 |
| 35% IPA, 84 h | 73.3 | 96.7 | 663 | 59.0 |
| 35% IPA, 84 h | 70.7 | 99.1 | 657 | 58.1 |
| 35% IPA, 84 h | 67.3 | 99.2 | 706 | 59.6 |
| 35% IPA, 84 h | 62.7 | 99.2 | 715 | 58.5 |

### Example 10

### Xylose Flux Test after Treatment with Various Acids or Glycerol

A further treatment test was carried out with flat sheets cut from spiral wound elements. The membrane tested was GE Osmonics Desal 5 DL membrane. The filtration unit used in the test was Alfa Laval LabStak M20.

The membrane sheets were pre-washed with a procedure similar to that of example 7.

After the pre-washing steps, the membrane sheets were treated by incubation in various test liquids at 25 to 70° C. for 72 hours. The test liquids were ion exchanged water, formic acid, lactic acid, glycerol and gluconic acid solutions with varying concentrations. After the incubation, the membrane sheets were flushed well at 25° C. with ion free water before assembling them to the nanofiltration test unit.

A xylose flux test with the treated membranes was carried out with a 24% DS industrial xylose solution, made in similar way as in Example 2. The xylose flux test was done at 30 bar at 65° C. and 30 bar at 70° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the sugar content for calculating the sugar fluxes. The treatment solutions and the dry substance fluxes measured with respective membranes are presented in Table 10.

TABLE 10

| | Xylose flux | Xylose flux |
|---|---|---|
| Treatment liquid, | at 65° C., | at 70° C., |
| time, temperature | g/h · m² | g/h · m² |
| Water, 72 h, 25° C. | 524 | 637 |
| Water, 72 h, 45° C. | 525 | 624 |
| Water, 72 h, 70° C. | 470 | 568 |
| 40% formic acid, 72 h, 25° C. | 551 | 671 |
| 40% formic acid, 72 h, 45° C. | 727 | 846 |
| 80% formic acid, 72 h, 25° C. | 687 | 796 |
| 40% lactic acid, 72 h, 70° C. | 1058 | 1209 |
| 80% lactic acid, 72 h, 70° C. | 1082 | 1292 |
| 40% glycerol, 72 h, 70° C. | 536 | 674 |
| 80% glycerol, 72 h, 70° C. | 613 | 657 |
| 10% gluconic acid, 72 h, 70° C. | 603 | 698 |
| 40% gluconic acid, 72 h, 70° C. | 361 | 409 |

### Example 11

### Liquid Flux and Sugar Flux and Purity Test for Various Sugars after Treatment with Formic Acid

A further treatment test was carried out with a 4 inch spiral wound membrane element. The membrane element tested was GE Osmonics Desal 5 DL. The filtration unit used in the test was GEA pilot model R unit.

The membrane elements were incubated first 24 hours with ion exchanged water at 20° C., then pre-washed with 0.3% Ultrasil 110 solution, 20 minutes at 1 bar at 30° C. circulating permeate back to the feed tank, rinsed well with ion exchanged water and thereafter washed with 2% acetic acid (30° C., 1 bar, 5 min) and rinsed well with ion exchanged water.

After the pre-washing steps, the membrane elements were assembled to the pilot unit and the treatment was carried out by circulating the treatment liquids with a reflux mode at a pressure of 2 bar and with a pumping speed of 0.2 m³/h at 68° C. for 96 hours. The test liquids were ion exchanged water (IEX) and 40% formic acid (FA). After the treatment, the membrane elements were flushed well with ion free water before the flux tests.

The first test with the pre-treated membranes was a xylose flux test carried out with a 21% DS industrial xylose solution, made in a similar way as in Example 2. The xylose flux test was done at 27 bar inlet pressure, 0.3 bar pressure difference over the 4″ element at 65° C., the cross flow velocity was adjusted to 3 m/s.

Thereafter the composition of the feed solution was adjusted by stepwise nanofiltration to xylose feed purities of 43%, 37% and 31% to mimic the conditions in production mode nanofiltration. The dry substance concentration of the feed was maintained at 21%. The filtration time before the measurements and sample taking was 30 minutes. The permeate flux values for each feed solution composition were registered and the permeate samples were analysed with HPLC to measure the composition of the permeates for calculating the sugar fluxes. The membrane treatment solutions and the compound fluxes measured with respective membranes are presented in Table 11.

TABLE 11

| | | | | Arabi- | |
|---|---|---|---|---|---|
| Treatment liquid, | Permeate | Glucose | Xylose | nose | Mannose |
| time, Xylose purity | flux, | flux, | flux, | flux, | flux, |
| in feed, %/ds | kg/h · m² | g/h · m² | g/h · m² | g/h · m² | g/h · m² |
| 40% FA, 96 h, | 17.6 | 66 | 1119 | 20 | 56 |
| xylose purity 43%/ | | | | | |
| DS | | | | | |
| 40% FA, 96 h, | 7.4 | 34 | 544 | 10 | 28 |
| xylose purity 37%/ | | | | | |
| DS | | | | | |
| 40% FA, 96 h, | 7.9 | 38 | 429 | 9 | 33 |
| xylose purity 31%/ | | | | | |
| DS | | | | | |
| Water, 96 h, xylose | 9.2 | 24 | 549 | 9 | 21 |
| purity 43%/ | | | | | |
| DS | | | | | |
| Water, 96 h, xylose | 3.8 | 20 | 273 | 5 | 18 |
| purity 37%/ | | | | | |
| DS | | | | | |
| Water, 96 h, xylose | 4.0 | 16 | 215 | 4 | 13 |
| purity 31%/ | | | | | |
| DS | | | | | |

| | | Xylose | Arabinose | Mannose |
|---|---|---|---|---|
| Treatment liquid, | Glucose purity | purity in | purity in | purity in |
| time, Xylose purity | in permeate | permeate, | permeate, | permeate, |
| in feed, %/DS | % on DS | % on DS | % on DS | % on DS |
| 40% FA, 96 h, | 3.3 | 56.0 | 1.0 | 2.8 |
| xylose purity 43%/ | | | | |
| DS | | | | |
| 40% FA, 96 h, | 3.6 | 57.3 | 1.0 | 3.0 |
| xylose purity 37%/ | | | | |
| DS | | | | |
| 40% FA, 96 h, | 4.5 | 50.6 | 1.1 | 3.9 |
| xylose purity 31%/ | | | | |
| DS | | | | |
| Water, 96 h, xylose | 2.5 | 56.8 | 0.9 | 2.2 |
| purity 43%/ | | | | |
| DS | | | | |
| Water, 96 h, xylose | 4.1 | 55.8 | 1.1 | 3.7 |
| purity 37%/ | | | | |
| DS | | | | |
| Water, 96 h, xylose | 3.9 | 52.8 | 1.0 | 3.2 |
| purity 31%/ | | | | |
| DS | | | | |

### Example 12

### Betaine Flux Test after Treatment with Formic Acid

A further treatment test was carried out with flat sheets cut from spiral wound elements. The membrane tested was GE Osmonics Desal 5 DL membrane. The filtration unit used in the test was Alfa Laval LabStak M20.

The membrane sheets were pre-washed with a procedure similar to that of example 7.

After the pre-washing steps, the membrane sheets were treated by incubation in pure water or 40% formic acid (FA) at 70° C. for 72 hours.

The nanofiltration feed for the flux test was a chromatographically separated fraction of vinasse having a DS of 14% and containing 48.5% betaine on DS. The betaine flux test was done at 28 bar at 68° C., and the cross flow velocity was adjusted to 3 m/s. The filtrations were done with a reflux mode, e.g. all permeates were introduced back into the feed tank. The filtration time before the measurements and sample taking and was 30 minutes.

The betaine flux values were registered and the permeate samples were analysed with HPLC to measure the betaine content for calculating the betaine flux. The treatment solutions and the betaine fluxes measured with respective membranes are presented in Table 12.

TABLE 12

| | Retention test | | Betaine flux test | | |
|---|---|---|---|---|---|
| | Water | | | | Betaine |
| Treatment | flux, | MgSO₄ | Permeate | Betaine | purity in |
| liquid, | kg/h · | retention, | flux, | flux, | permeate, |
| time | m² | % | kg/h · m² | g/m2/h | % on DS |
| Water, 72 h | 60.0 | 91.4 | 38.9 | 1137 | 31.1 |
| 40% FA, 72 h | 76.5 | 95.8 | 64.9 | 1933 | 32.1 |

### Example 13

### Glucose Flux Test after Treatment with Formic Acid

A further treatment test was carried out with flat sheets cut from spiral wound element. The membrane tested was GE Osmonics Desal 5 DL membrane. The filtration unit used in the test was Alfa Laval LabStak M20.

The membrane sheets were pre-washed with a procedure similar to that of example 7.

After the pre-washing steps, the membrane sheets were treated by incubation in various test liquids at 70° C. for 72 hours. The membrane treatment liquids were ion exchanged water and 40% formic acid.

The nanofiltration feed for the glucose flux test was industrial dextrose corn syrup having a glucose purity of 95.7% with a dry substance content of 40%. The glucose flux test was done at 30 bar at 66° C., and the cross flow velocity was adjusted to 3 m/s. The filtrations were done with a reflux mode, e.g. all permeates were led back into the feed tank. The filtration time before the measurements and sample taking and was 30 minutes.

The liquid flux values were registered and the permeate samples were analysed with HPLC to measure the glucose content in the permeate for calculating the glucose flux. The treatment solutions and the glucose fluxes measured with respective membranes are presented in Table 13.

TABLE 13

| Treatment | Water | MgSO₄ | Permeate | Glucose | Glucose purity |
|---|---|---|---|---|---|
| liquid, | flux, | retention, | flux, | flux, | in permeate, |
| time | kg/h · m² | % | kg/h · m² | g/m2/h | % on DS |
| Water, | 81.6 | 99.2 | 6.8 | 2508 | 99.4 |
| 72 h | | | | | |
| 40% FA, | 93.3 | 99.1 | 17.2 | 6419 | 99.2 |
| 72 h | | | | | |

### Example 14

### Liquid Flux, Xylose Flux and Xylose Purity Test after Treatment with Formic Acid

A membrane treatment test was carried out with flat sheets cut from spiral wound elements. The membrane tested was Dow NF 270 membrane. The filtration unit used in the test was Alfa Laval LabStak M20.

All the tested membrane sheets were first washed with ion free water for 48 hours at 25° C. to remove all membrane preserving compounds. Then the membranes were washed with an alkaline washing agent for 30 minutes by soaking in 0.1% alkaline solution (Ecolab Ultrasil 112) at 30° C. The membranes were flushed with ion free water. The next step was to soak the membranes for 2 minutes in 0.1% acetic acid at 30° C. followed by flushing with IEX (ion exchange) water.

After the pre-washing steps, the membrane sheets were treated by incubation in various test liquids at 70° C. for 120 hours. The test liquids were formic acid (FA) solutions with varying concentrations. After the incubation, the membrane sheets were flushed well with ion free water before assembling them to the nanofiltration test unit.

A xylose flux test with the treated membranes was carried out with a 25% DS industrial xylose solution, made in the same way as in Example 2. The xylose flux test was done at 30 bar at 65° C., and the cross flow velocity was adjusted to 3 m/s. The filtrations were done with a reflux mode, e.g. all permeates were introduced back into the feed tank. The filtration time before the measurements and sample taking and was 30 minutes.

The permeate flux values were registered and the permeate samples were analysed with HPLC to measure the xylose content for the calculation of xylose flux. The treatments and the xylose fluxes measured with respective membranes are presented in Table 7.

TABLE 14

| | Permeate | Xylose | Xylose purity |
|---|---|---|---|
| Treatment liquid, | flux, | flux, | in permeate, |
| time | kg/h · m² | g/m2/h | % on DS |
| Water, 120 h | 6.7 | 713 | 59.2 |
| 40% FA, 120 h | 13.2 | 1430 | 58.4 |
| 15% FA, 120 h | 11.8 | 1230 | 59.1 |

### Example 15

### Liquid Flux and the Flux of Ionic Compounds after Treatment with Formic Acid

A further treatment test was carried out with a 4 inch spiral wound membrane element. The membrane element tested was GE Osmonics Desal 5 DL. The filtration unit used in the test was GEA pilot model R unit.

The membrane elements were incubated first 24 hours with ion exchanged water at 20° C., then pre-washed with 0.3% Ultrasil 110 solution, 20 minutes at 1 bar at 30° C. circulating permeate back to the feed tank, rinsed well with ion exchanged water and thereafter washed with 2% acetic acid (30° C., 1 bar, 5 min) and rinsed well with ion exchanged water.

After the pre-washing steps, the membrane elements were assembled to the pilot unit and the treatment was carried out by circulating the treatment liquids at reflux mode with 2 bar pressure with a pumping speed of 0.2 m³/h at 68° C. for 96 hours. The test liquids were ion exchanged water (IEX) and 40% formic acid (FA). After the treatment, the membrane elements were flushed well with ion free water before the flux tests.

The first test with the pre-treated membranes was a xylose flux test carried out with a 21% DS industrial xylose solution, made in a similar way as in Example 2. The xylose flux test was done at 27 bar inlet pressure, 0.3 bar pressure difference over the 4″ element at 65° C.

Thereafter the composition of the feed solution was adjusted with stepwise nanofiltration to xylose feed purities of 43%, 37% and 31% on DS to mimic the conditions in production mode nanofiltration. The dry substance concentration of the feed was maintained at 21%. The filtration time before the measurements and sample taking was 30 minutes. The permeate flux values with each feed solution compositions were registered and the permeate samples were analysed with HPLC to measure the composition of the permeates for calculating the fluxes of the ionic compounds. The permeate flux values were registered and the permeate samples were analysed with HPLC and conductivity meter to measure the content of salts and ionic compounds for calculating the salt fluxes. The treatment solutions and the compound fluxes measured with respective membranes are presented in Table 15.

TABLE 15

| Treatment liquid, time, | | Acetate | Xylonic acid |
|---|---|---|---|
| xylose purity | Salt flux | flux | flux |
| in feed %/ds | g/h · m² | g/h · m² | g/h · m² |
| 40% FA, 96 h, | 36 | 252 | 212 |
| xylose purity 43%/DS | | | |
| 40% FA, 96 h, | 17 | 116 | 97 |
| xylose purity 37%/DS | | | |
| 40% FA, 96 h, | 14 | 136 | 146 |
| xylose purity 31%/DS | | | |
| Water, 96 h, xylose | 19 | 131 | 111 |
| purity 43%/DS | | | |
| Water, 96 h, xylose | 8 | 58 | 46 |
| purity 37%/DS | | | |
| Water, 96 h, xylose | 8 | 70 | 96 |
| purity 31%/DS | | | |
| | Salt | Acetate | Xylonic acid |
| Treatment liquid, | purity in | purity in | purity in |
| time, xylose purity | permeate | permeate | permeate |
| in feed %/DS | %/DS | %/DS | %/DS |
| 40% FA, 96 h, | 1.8 | 12.6 | 10.6 |
| xylose purity 43%/DS | | | |
| 40% FA, 96 h, | 1.8 | 12.2 | 10.2 |
| xylose purity 37%/DS | | | |
| 40% FA, 96 h, | 1.7 | 16.0 | 17.2 |
| xylose purity 31%/DS | | | |
| Water, 96 h, | 1.9 | 13.6 | 11.5 |
| xylose purity 43%/DS | | | |
| Water, 96 h, | 1.6 | 11.9 | 9.5 |
| xylose purity 37%/DS | | | |
| Water, 96 h, | 1.9 | 17.3 | 23.5 |
| xylose purity 31%/DS | | | |

### Example 16

### Permeate Flux, Glucose Flux, Pure Xylose Flux, Xylose Flux and Xylose Purity Test after Treatment with Lactic Acid, Formic Acid and Pure Xylose

A membrane treatment test was carried out with flat sheets cut from spiral wound elements. The membrane tested was Osmonics DL membrane. The filtration unit used in the test was Alfa Laval LabStak M20.

All the tested membrane sheets were pre-washed with the same methods as in example 15.

After the pre-washing steps, the membrane sheets were treated by incubation in various test liquids at 70° C. for 23 to 145 hours. The test liquids were lactic acid (LA) and formic acid (FA) with varying concentrations. After the soaking treatment, the membrane sheets were flushed well with ion free water before assembling them to the nanofiltration test unit.

A glucose flux test with the treated membranes was carried out with a 40% pure glucose solution. The glucose flux test was done at 30 bar/65° C. using 3 m/s cross flow velocity. The filtrations were done with a reflux mode, e.g. all permeates were introduced back into the feed tank. The filtration time before the measurements and sample taking and was 30 minutes.

A xylose flux test with the treated membranes was carried out with a 23% DS industrial xylose solution, obtained in a similar way as in Example 2. The xylose flux test was done at 30 bar/65° C. using 3 m/s cross flow velocity. The filtrations were done with a reflux mode, e.g. all permeates were introduced back into the feed tank. The filtration time before the measurements and sample taking was 30 minutes.

The permeate flux values were registered and the permeate samples were analysed with HPLC to measure the xylose content for the calculation of xylose flux. The treatments and the xylose fluxes measured with respective membranes are presented in Table 16.

TABLE 16

| | Pure glucose | Xylose | Xylose flux |
|---|---|---|---|
| | flux test | flux test | test |
| | Glucose | Permeate | Xylose |
| Treatment | flux, | flux, | flux, |
| liquid, time | g/m²/h | kg/h · m² | g/m²/h |
| Water, 110 h | 1630 | 3.5 | 327 |
| 40% FA, 74 h | 7655 | 7.8 | 783 |
| 55% LA, 74 h | 7689 | 7.9 | 730 |
| 55% LA, 74 h | 6394 | 7.4 | 731 |
| 55% LA, 74 h | 8717 | 8.1 | 699 |
| 69% LA, 74 h | 5626 | 7.6 | 759 |
| 41% LA, 74 h | 6849 | 7.6 | 718 |
| 55% LA, 111 h | 9506 | 8.7 | 722 |
| 55% LA, 37 h | 6390 | 8.0 | 833 |
| 65% LA, 100 h | 8757 | 9.1 | 792 |
| 45% LA, 100 h | 9689 | 8.1 | 864 |
| 65% LA, 48 h | 6543 | 7.5 | 769 |
| 45% LA, 48 h | 5706 | 7.1 | 706 |

1. A process of treating polymeric nanofiltration membranes before separation of low molecular weight compounds from a solution containing the same by nanofiltration, wherein the treatment of the nanofiltration membranes is performed with an organic liquid under conditions which enhance the flux of the low molecular weight compounds to the nanofiltration permeate.

2. The process as claimed in claim 1, wherein the organic liquid is a solution comprising one or more compounds selected from organic acids and alcohols, and wherein the organic acid is selected from formic acid, acetic acid, propionic acid, lactic acid, oxalic acid, citric acid, glycolic acid, and aldonic acids.

3. (canceled)

4. The process as claimed in claim 2, wherein the alcohol is selected from methanol, ethanol, n-propanol, isopropanol and glycerol.

5. The process as claimed in claim 2, wherein the concentration of said compounds in the organic liquid is one of 2% to 98% by weight or 10% to 60% by weight.

6. The process as claimed in claim 1, wherein the treatment is performed at a temperature of one of 20° C. to 100° C., 20° C. to 90° C., or 40° C. to 80° C.

7. The process as claimed in claim 1, wherein the treatment time is one of 1 to 150 hours or 2 to 100 hours.

8. The process as claimed in claim 1, wherein the treatment is performed with a solution of formic acid under the following conditions:
an acid concentration of one of 5% to 80% by weight or 10% to 45% by weight
a treatment temperature of one of 40° C. to 80° C. or 65° C. to 75° C., and
a treatment time of 20 to 90 hours.

9. The process as claimed in claim 1, wherein the treatment is performed with a solution of lactic acid under the following conditions:
an acid concentration of one of 10% to 95% by weight or 30% to 85% by weight,
a treatment temperature of one of 40° C. to 80° C. or 65° C. to 75° C., and
a treatment time of 20 to 90 hours.

10. The process as claimed in claim 1, wherein the treatment is performed with a solution of isopropyl alcohol under the following conditions:
an alcohol concentration of one of 5% to 80% by weight or 15% to 45% by weight,
a treatment temperature of one of 40° C. to 80° C. or 65° C. to 75° C., and
a treatment time of 20 to 90 hours.

11. The process as claimed in claim 1, wherein the treatment is performed—with a solution of acetic acid under the following conditions:
an acid concentration of one of 10% to 100% by weight or −10% to 60% by weight,
a treatment temperature of one of 40° C. to 80° C. or 65° C. to 75° C., and
a treatment time of one of 30 to 70 hours or 40 to 60 hours.

12. The process as claimed in claim 1, wherein the low molecular weight compounds have a molar mass of up to 360 g/mol.

13. The process as claimed in claim 1, wherein the low molecular weight compounds are selected from sugars having a flux to the nanofiltration permeate in the range of one of 20 to 15,000 g/m²h, 100 to 8000 g/m²h, or 100 to 4000 g/m²h, sugar alcohols, inositols, betaine, glycerol, amino acids, uronic acids, carboxylic acids, aldonic acids and inorganic and organic salts.

14. The process as claimed in claim 12, wherein the sugars are monosaccharides, and wherein the monosaccharides are selected from pentoses and hexoses.

15. (canceled)

16. The process as claimed in claim 13, wherein the pentoses are selected from xylose having a flux- to the nanofiltration permeate in the range of one of 100 to 10,000 g/m²h, 100 to 8000 g/m²h, or 100 to 4000 g/m²h, and arabinose.

17. The process as claimed in claim 13, wherein the hexoses are selected from glucose having a flux to the nanofiltration permeate in the range of one of 200 to 15,000 g/m²h, 200 to 10,000 g/m²h, or 200 to 8,000 g/m²h, galactose, rhamnose, mannose, fructose, isomaltose and tagatose.

18. The process as claimed in claim 1, wherein the solution comprising the low molecular weight compounds is selected from plant-based biomass hydrolysates and biomass extracts,
starch hydrolysates, oligosaccharide-containing syrups, glucose syrups, fructose syrups, maltose syrups, corn syrups and lactose-containing dairy products.

19. The process as claimed in claim 1, wherein the polymeric nanofiltration membranes are polyamide membranes, and wherein the polyamide membranes are polypiperazineamide membranes.

20. (canceled)

21. The process as claimed in claim 1, wherein the flux of the low molecular weight compounds to the nanofiltration permeate is in the range of 10 to 20 000 g/m²h.

22. (canceled)

23. (canceled)

24. (canceled)

25. The process as claimed in claim 1, wherein the process further comprises nanofiltration of the solution comprising low molecular weight compounds to obtain a nanofiltration retentate and a nanofiltration permeate, whereby said low molecular weight compounds are separated into the nanofiltration permeate.

26. A process of separating and recovering xylose from a xylose-containing solution by nanofiltration with a polymeric nanofiltration membrane, the process comprising:
treating the membrane with an organic-liquid to obtain a treated nanofiltration membrane, the organic liquid comprising a compound selected from formic acid, lactic acid, acetic acid, isopropanol, ethanol and methanol in the following conditions:
compound concentration of 10 to 80% by weight,
treatment temperature of 40 to 90° C., and
treatment time of 2 to 100 hours;
nanofiltering the xylose-containing solution with the treated nanofiltration membrane with a xylose flux of 100 to 10 000 g xylose/m²h to the nanofiltration permeate; and
recovering the xylose from the nanofiltration permeate.
